(19) United States
(12) Patent Application Publication
(10) Pub. No.: US 2024/0354009 A1
(43) Pub. Date: Oct. 24, 2024

(54) COMPUTER SYSTEM

(71) Applicant: Apacer Technology Inc., New Taipei City (TW)

(72) Inventor: Jiunn-Chang Lee, New Taipei City (TW)

(21) Appl. No.: 18/614,057

(22) Filed: Mar. 22, 2024

(30) Foreign Application Priority Data
Apr. 24, 2023 (TW) 112115220

(51) Int. Cl. G06F 3/06

(52) U.S. Cl. CPC G06F 3/0619; G06F 3/0659; G06F 3/0673

(57) ABSTRACT

A computer system is provided. The computer system includes a data storage device having a controller and a data storage unit connected to the controller, wherein the controller includes a firmware which defines a backup and recovery operation, and the data storage unit includes a first storage sector and a second storage sector. The first storage sector stores a backup file and has a resident program installed therein. The resident program is executed after the computer system is normally booted for periodically transmitting a handshake instruction to perform a handshaking with the controller. When the computer system is booted and a preset number that the controller does not receive the handshake instruction is reached within a preset time period, the firmware executes the backup and recovery operation to restore the backup file in the first storage sector through a cooperation between the first storage sector and the second storage sector.

### CROSS-REFERENCE TO RELATED APPLICATION

This application claims priority to Taiwan Patent Application No. 112115220, filed on Apr. 24, 2023. The entire contents of the above-mentioned patent application are incorporated herein by reference for all purposes.

### FIELD OF THE INVENTION

The present disclosure relates to a computer system, and more particularly to a computer system capable of self-monitoring and automatically restoring from the backup file.

### BACKGROUND OF THE INVENTION

Generally, the computer system would store a backup file, so when the computer system is abnormal, user can trigger the recovery function of the computer system by executing the recovery program or pressing the recovery button so as to restore from the back files.

However, for the conventional computer system above, the user has to personally participate in the recovery operation, and the computer system cannot self-monitor and automatically restore the backup file, which leads to problems of incapable of maintaining automated operation and low operation efficiency in the computer system.

### SUMMARY OF THE INVENTION

An object of the present disclosure is to provide a computer system. When the computer system is booted and a preset number that a controller of a data storage device in the computer system does not receive a handshake instruction transmitted by a resident program is reached within a preset time period, a firmware in the data storage device automatically executes a backup and recovery operation through a cooperation between the first storage sector and the second storage sector. Whereby, the computer system is capable of self-monitoring the anomaly and automatically restoring a backup file as the anomaly is detected, so as to maintain the operation and improve the efficiency.

In accordance with an aspect of the present disclosure, a computer system is provided. The computer system includes a data storage device having a controller and a data storage unit connected to the controller, wherein the controller includes a firmware which defines a backup and recovery operation, and the data storage unit includes a first storage sector and a second storage sector. The first storage sector is configured to manage a first storage space of the data storage unit and have a backup file stored therein, wherein a resident program is installed in the first storage sector, and the resident program is executed after the computer system is normally booted for periodically transmitting a handshake instruction to perform a handshaking with the controller. Moreover, the first storage sector includes a first mapping table for managing a plurality of first logical block addresses which correspond to a plurality of physical addresses of the first storage space, and the first storage sector is default for performing data writing and/or reading with a host, thereby writing data to the plurality of physical addresses of the first storage space according to the first mapping table. Furthermore, the second storage sector is configured to manage a second storage space of the data storage unit, wherein the second storage sector includes a second mapping table for managing a plurality of second logical block addresses which correspond to a plurality of physical addresses of the second storage space, and each of the plurality of second logical block addresses corresponds to a corresponding one of the plurality of first logical block addresses by having a preset shift of logical block address therebetween. When the computer system is booted and a preset number that the controller does not receive the handshake instruction transmitted by the resident program is reached within a preset time period, the firmware executes the backup and recovery operation to backup and restore the backup file in the first storage sector through a cooperation between the first storage sector and the second storage sector. In addition, the backup and recovery operation includes steps of performing a normal operation procedure, wherein during data writing, the second storage sector replaces the first storage sector to write data to at least one of the plurality of physical addresses of the second storage space according to the second mapping table, and during data reading, if a physical address which corresponds to one of the plurality of second logical block addresses has data stored therein, the controller reads data therefrom, and if a physical address which corresponds to one of the plurality of second logical block addresses does not have data stored therein, the controller shifts the one of the plurality of second logical block addresses corresponding thereto the preset shift of logical block address to refer back to the corresponding one of the plurality of first logical block addresses, so as to read data from a physical addresses corresponding to the corresponding one of the plurality of first logical block addresses; and performing a recovery procedure, wherein data stored in the plurality of physical addresses corresponding to the plurality of second logical block addresses are erased, and each of the plurality of second logical block addresses is shifted the preset shift of logical block address to refer back to the corresponding one of the plurality of first logical block addresses, so as to read data stored in a physical address corresponding to the corresponding one of the plurality of first logical block addresses.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a schematic view illustrating the architecture of a computer system according to an embodiment of the present disclosure;

FIG. 2 is a flow chart showing steps of a backup and recovery operation of the computer system in FIG. 1;

FIG. 3 is a schematic view illustrating the relationship between logical block addresses and physical addresses of a first mapping table in a first storage sector according to an embodiment of the present disclosure; and

FIG. 4 is a schematic view illustrating the relationship between logical block addresses and physical addresses of a second mapping table in a second storage sector according to an embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

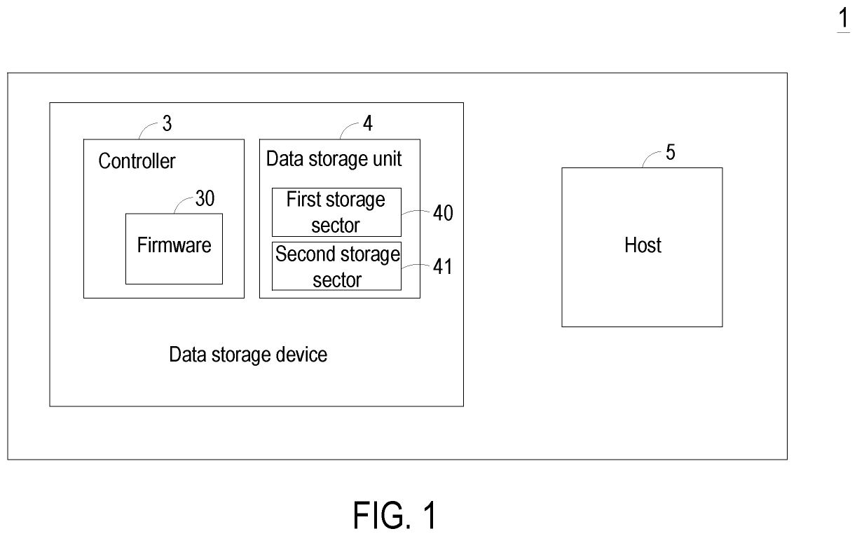

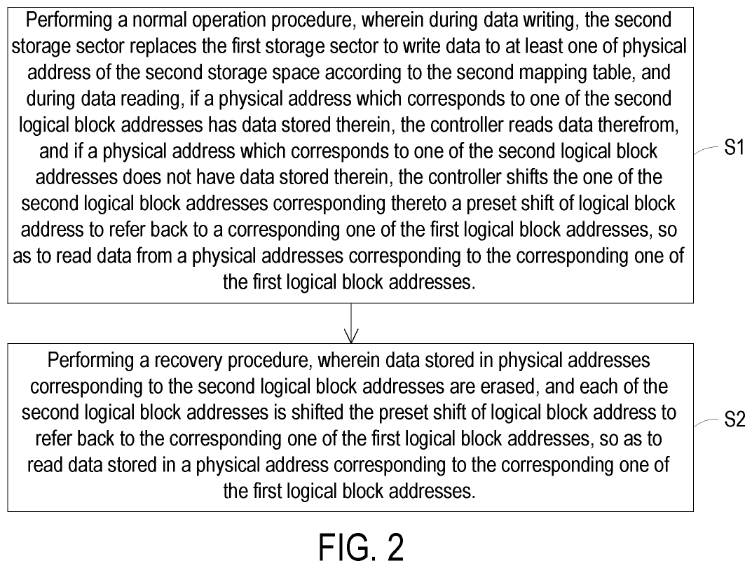

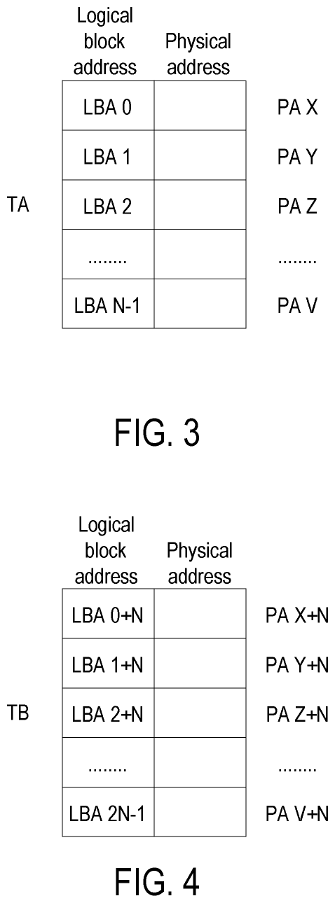

Please refer to FIG. 1, FIG. 2, FIG. 3 and FIG. 4, wherein FIG. 1 is a schematic view illustrating the architecture of a computer system according to an embodiment of the present disclosure, FIG. 2 is a flow chart showing steps of a backup and recovery operation of the computer system in FIG. 1, FIG. 3 is a schematic view illustrating the relationship between logical block addresses and physical addresses of a first mapping table in a first storage sector according to an embodiment of the present disclosure, and FIG. 4 is a schematic view illustrating the relationship between logical block addresses and physical addresses of a second mapping table in a second storage sector according to an embodiment of the present disclosure. As shown in FIG. 1 to FIG. 4, a computer system 1 of the present disclosure includes a data storage device 2, a controller 3 and a data storage unit 4. In an embodiment, the data storage device 2 is a solid state disk (SSD), but not limited thereto. The controller 3 includes a firmware 30, and the firmware 30 defines a backup and recovery operation.

The data storage unit 4 is connected to the controller 3 and includes a first storage sector 40 and a second storage sector 41. The first storage sector 40 manages a first storage space of the data storage unit 4, and stores a backup file, wherein the backup file includes, but not limited to, the operation system and other data files. Moreover, a resident program is installed in the first storage sector 40 and is executed after the computer system 1 is normally booted for periodically transmitting a handshake instruction to the controller 3 to perform a handshaking with the controller 3. The first storage sector 40 includes a first mapping table TA for managing a plurality of first logical block addresses (LBAs) which correspond to a plurality of physical addresses (PAS) in the first storage space. In addition, the first storage sector 40 is default for performing data writing and/or reading with a host 5, in which data is written to the plurality of physical addresses of the first storage space according to the first mapping table TA.

The second storage sector 41 manages a second storage space of the data storage unit 4. Moreover, the second storage sector 41 includes a second mapping table TB for managing a plurality of second logical block addresses which correspond to a plurality of physical addresses (PAS) in the second storage space, wherein each of the plurality of second logical block addresses corresponds to one of the plurality of first logical block addresses and has a preset shift of logical block address with the corresponding one of the plurality of first logical block addresses.

In the present disclosure, if a preset number that the controller 3 does not receive the handshake instruction transmitted by the resident program as the computer system is booted is achieved within a preset time period, the firmware 30 executes a backup and recovery operation to restore the backup file in the first storage sector 40 through a cooperation between the first storage sector 40 and the second storage sector 41.

In some embodiments, the preset number is at least one, and the preset number is the continuous accumulation number that the controller 3 does not receive the handshake instruction transmitted by the resident program.

Furthermore, the backup and recovery operation executed by the firmware 30 includes following steps.
Step S1: Perform a normal operation procedure. During data writing, the first storage sector 40 is replaced by the second storage sector 41, and data is written to at least one of the physical addresses of the second storage space according to the second mapping table TB. During data reading, if a physical address which corresponds to one of the second logical block addresses has data stored therein, the controller 3 reads data therefrom, and if a physical address which corresponds to one of the second logical block addresses does not have data stored therein, the controller 3 shifts said one of the second logical block addresses corresponding thereto the preset shift of logical block address to refer back to the corresponding one of the first logical block addresses, so as to read data from a physical addresses corresponding to the corresponding one of the first logical block addresses.
Step S2: Perform a recovery procedure. Data stored in all physical addresses corresponding to the second logical block addresses are erased, and each of the second logical block addresses is shifted the preset shift of logical block address to refer back to the corresponding one of the first logical block addresses, so as to read data stored in a physical address corresponding to the corresponding one of the first logical block addresses.

In some embodiments, the storage capacity of the first storage space is equal to the storage capacity of the second storage space. Please refer to FIG. 3 and FIG. 4. In some embodiments, assuming that the logical block addresses managed by the first mapping table TA are LBA(0)˜LBA(N−1), then the logical block addresses managed by the second mapping table TB are LBA(0+N)˜LBA(N−1+N). Accordingly, the first mapping table TA and the second mapping table TB are logically corresponding to each other by having a shift of logical block address therebetween, such as, N, in which N is an integer. Each of the logical block addresses is assigned to an independent physical address PA (for example, LBA(0) is assigned to PA(X), LBA(N−1) is assigned to PA(V)), and the physical addresses store the written data. In addition, every time the data storage unit 4 is used for performing data reading and/or writing with the host 5, only one storage sector represented by the first mapping table TA or the second mapping table TB will be recognized by the host 5. In the initial booting stage of the computer system 1, the host 5 is default to recognize the first mapping table TA, so that data is written to the physical addresses corresponding to the first mapping table TA.

When performing the normal operation procedure, the host 5 is switched to recognize the second mapping table TB. At this time, the host 5 stops writing to the physical addresses corresponding to the first mapping table TA, namely, in the normal operation procedure, data is always written to the physical addresses corresponding to the second mapping table TB. During data reading, if physical addresses which correspond to the second logical block addresses have data stored therein, data is provided thereby; otherwise, through performing an algorithm, the second logical block addresses which correspond to the physical addresses without data stored therein are shifted the preset shift of logical block address to refer back to the corresponding ones of the first logical block addresses in the first mapping table TA, so that data is provided by the physical addresses corresponding to the corresponding ones of the first logical block addresses.

Then, when performing the recovery procedure, data stored in all physical addresses corresponding to the second logical block addresses of the second mapping table TB are erased, so that there are no effective physical addresses corresponding to the second logical block addresses in the second mapping table TB. Accordingly, as described above, through performing the algorithm, the second logical block addresses corresponding to the physical addresses without data stored therein are shifted the preset shift of logical block address to refer back to the corresponding ones of the first logical block addresses in the first mapping table TA, and thus, data is provided by the physical addresses corresponding to the corresponding ones of the first logical block addresses, thereby completing the backup and recovery operation.

In conclusion, the present disclosure provides a computer system. When the computer system is booted and the preset number that the controller of the data storage device does not receive the handshake instruction transmitted by the resident program is reached within the preset time period, the firmware in the data storage device automatically executes the backup and recovery operation to restore the backup file in the first storage sector through the cooperation between the first storage sector and the second storage sector. Whereby, the computer system is capable of self-monitoring the anomaly and automatically restoring the backup file as the anomaly is detected, so as to maintain the operation and improve the efficiency.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A computer system, comprising:
a data storage device, comprising;
a controller comprising a firmware, wherein the firmware defines a backup and recovery operation; and
a data storage unit connected to the controller, comprising:
a first storage sector configured to manage a first storage space of the data storage unit and have a backup file stored therein, wherein a resident program is installed in the first storage sector, and the resident program is executed after the computer system is normally booted for periodically transmitting a handshake instruction to perform a handshaking with the controller, and wherein the first storage sector comprises a first mapping table for managing a plurality of first logical block addresses which correspond to a plurality of physical addresses of the first storage space, and the first storage sector is default for performing data writing and/or reading with a host, thereby writing data to the plurality of physical addresses of the first storage space according to the first mapping table; and
a second storage sector configured to manage a second storage space of the data storage unit, wherein the second storage sector comprises a second mapping table for managing a plurality of second logical block addresses which correspond to a plurality of physical addresses of the second storage space, and each of the plurality of second logical block addresses corresponds to a corresponding one of the plurality of first logical block addresses by having a preset shift of logical block address therebetween,
wherein when the computer system is booted and a preset number that the controller does not receive the handshake instruction transmitted by the resident program is reached within a preset time period, the firmware executes the backup and recovery operation to backup and restore the backup file in the first storage sector through a cooperation between the first storage sector and the second storage sector; and
wherein the backup and recovery operation comprises steps of:
performing a normal operation procedure, wherein during data writing, the second storage sector replaces the first storage sector to write data to at least one of the plurality of physical addresses of the second storage space according to the second mapping table, and during data reading, if a physical address which corresponds to one of the plurality of second logical block addresses has data stored therein, the controller reads data therefrom, and if a physical address which corresponds to one of the plurality of second logical block addresses does not have data stored therein, the controller shifts the one of the plurality of second logical block addresses corresponding thereto the preset shift of logical block address to refer back to the corresponding one of the plurality of first logical block addresses, so as to read data from a physical addresses corresponding to the corresponding one of the plurality of first logical block addresses; and
performing a recovery procedure, wherein data stored in the plurality of physical addresses corresponding to the plurality of second logical block addresses are erased, and each of the plurality of second logical block addresses is shifted the preset shift of logical block address to refer back to the corresponding one of the plurality of first logical block addresses, so as to read data stored in a physical address corresponding to the corresponding one of the plurality of first logical block addresses.

2. The computer system as claimed in claim 1, wherein a storage capacity of the first storage space is equal to a storage capacity of the second storage space.

3. The computer system as claimed in claim 1, wherein the preset number is at least one.

4. The computer system as claimed in claim 1, wherein the preset number is a continuous accumulation number that the controller does not receive the handshake instruction transmitted by the resident program.
